(19) United States
(12) Patent Application Publication
(10) Pub. No.: US 2012/0170778 A1
(43) Pub. Date: Jul. 5, 2012

(54) Acoustic transducer

(75) Inventor: Suo-he Wei, Shenzhen (CN)

(73) Assignees: AMERICAN AUDIO COMPONENTS INC., La Verne, CA (US); AAC ACOUSTIC TECHNOLOGIES (SHENZHEN) CO., LTD., Shenzhen (CN)

(21) Appl. No.: 13/325,050

(22) Filed: Dec. 13, 2011

(30) Foreign Application Priority Data
Dec. 31, 2010 (CN) 201020692662.7

(51) Int. Cl. H04R 1/00

(52) U.S. Cl. 381/191; 381/398

(57) ABSTRACT

An acoustic transducer includes a diaphragm defining a center portion and a supporting portion surrounding the center portion and a coil attached to the diaphragm and defining a pair of leading wires. The center portion defines a lower surface connected to the coil, an upper surface opposite to the lower surface, and at least a pair of protrusion portions extending from the lower surface toward the upper surface for receiving the leading wires of the coil.

### FIELD OF THE INVENTION

The present disclosure relates to the art of acoustic transducers and, particularly to an acoustic transducer having a diaphragm.

### DESCRIPTION OF RELATED ART

Generally, an electronic device, such as a mobile phone, uses an acoustic transducer as a sound generator.

A typically acoustic transducer 100′ includes a holder 1′, a magnetic system 4′ received in the holder 1′, a diaphragm 3′ attached on the holder 1′ and covered the magnetic system 4′, and a coil 4′ attached to the diaphragm 3′. The diaphragm 3′ defines a lower surface 31′ for positing coil 2′. The coil 2′ defines a body 21′ and a pair of leading wires 22′ drawn out from the body 21′ at positions where are close to the diaphragm 3′. When the coil 2′ and the diaphragm 3′ are to be bonded and fixed to each other, the leading wires 22′ directly attached on the lower surface 31′ of the diaphragm 3′.

In work, the diaphragm 3′ can be vibrated approaching and away from the magnetic system 4′ in a vibrating direction. The lower surface 31′ of the diaphragm 3 forms a vibrating space 5′ together with an upper surface of the holder 1′ for the diaphragm 3′ vibrates approaching the magnetic system 4′. A height of the vibrating space 5′ is labeled as reference number H1.

However, the height of the vibrating space is too small to provide a sufficient vibrating space for the diaphragm. Thus, the structure of the typical acoustic transducer can not provide an excellent acoustic capability. Therefore, it is desirable to provide an acoustic transducer which can overcome the above-mentioned problem.

### BRIEF DESCRIPTION OF THE DRAWINGS

FIG. 1 is a cross-sectional view of a typical acoustic transducer related to the present disclosure;

FIG. 2 is a cross-sectional view of an acoustic transducer in accordance with an exemplary embodiment of the present disclosure;

FIG. 3 is an illustrative exploded view of a diaphragm of the acoustic transducer;

FIG. 4 is similar to FIG. 1, but from another aspect; and

FIG. 5 is an illustrative rear view of the diaphragm.

### DETAILED DESCRIPTION

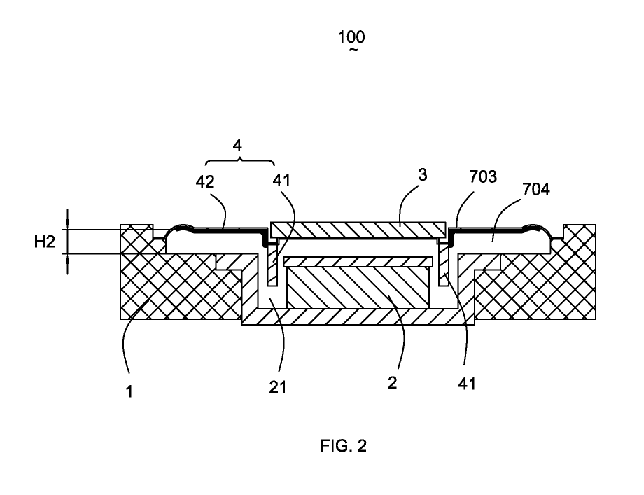

Referring to FIG. 2, a acoustic transducer 100, in the exemplary embodiment of the present invention, comprises a holder 1 forming a hollow space (no labeled), a magnetic system 2 received in the hollow space and defining a magnetic gap 21, a diaphragm 3 mounted on the holder 1, and a coil 4 directly or indirectly attached to the diaphragm 3 and partially received in the magnetic gap 21. The coil 4 defines a body portion 41 and a pair of leading wires 42 drawn out from the body 41 at positions where are close to the diaphragm 3.

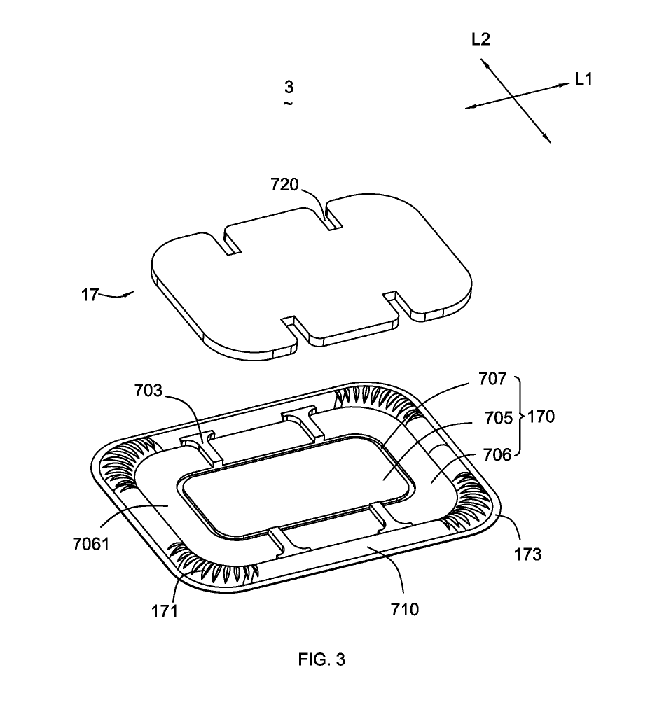

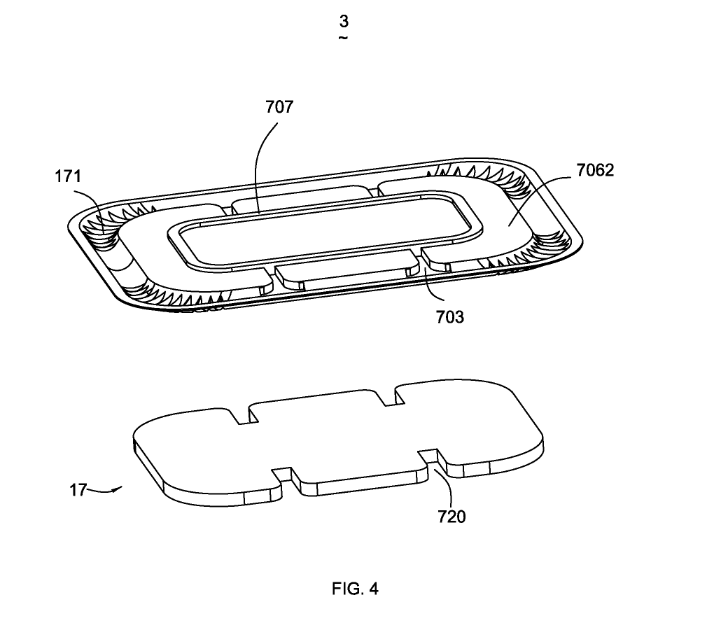

Referring to FIGS. 3 and 4, the diaphragm 3 has a longitudinal direction L1 and a lateral direction L2 perpendicular to the longitudinal direction L1. The diaphragm 3 defines a center portion 170, an arcuate portion 710 connected with the center portion 170, a supporting portion 173 connected with the arcuate portion 710 for fixing the diaphragm 3 on the holder 1 firmly, and a vibrating part 17 attached to the center portion 170. The arcuate portion 710 defines a plurality of corrugations 171 at the corner thereof.

Referring to FIGS. 2 and 3, the arcuate portion 710 is farther away from the magnetic system 2 than the center portion 170. The vibrating part 17 is configured to be a plate.

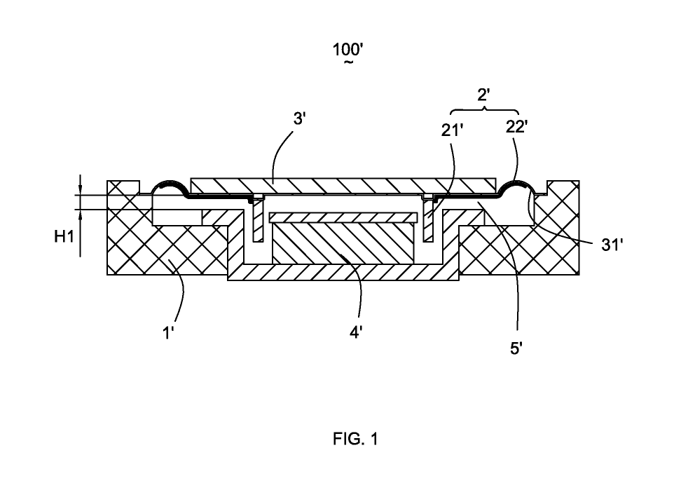

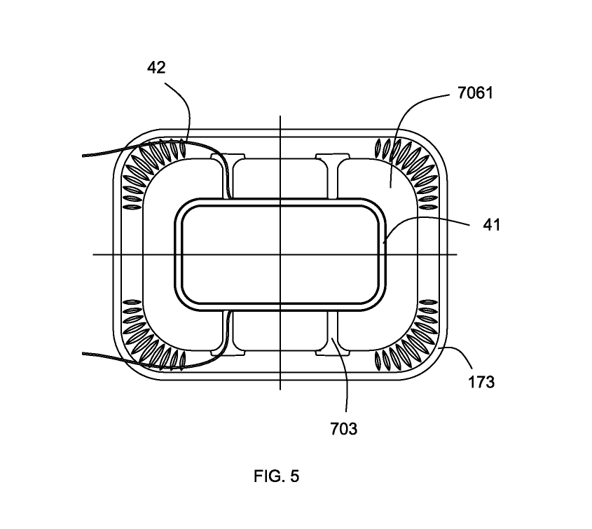

Referring to FIGS. 3 through 5, the center portion 170 defines an inner zone 705, an annular mounting zone 707 extending from the inner zone 705 and surrounding the inner zone 705 for mounting the coil 4, and an outer zone 706 extending from the mounting zone 707 and surrounding the mounting zone 707. The inner zone 705 is coplanar with respect to the outer zone 706. The mounting zone 707 protrudes toward the magnetic system 2 for fixing the coil 4 firmly. The outer zone 706 defines a lower surface 7061, an upper surface 7062 opposite to the lower surface 7061 for positing the vibrating part 17, and at least a pair of protrusion portions 703 extending from the lower surface 7061 toward the upper surface 7062 for receiving the leading wires 42 of the coil 4. In this description, the protrusion portions 703 are protruded out of an upper surface 7062 of the outer zone 706. Referring to FIG. 1, the protrusion portions 703 of the diaphragm 3 forms a vibrating space 704 together with an upper surface of the holder 1 for the diaphragm 3 vibrates approaching the magnetic system 2. A height of the vibrating space 704 is labeled as reference number H2. Referring to FIG. 2, the height of the vibrating space H2 is increased in comparison with the typical acoustic transducer.

Referring to FIGS. 2 to 4, the vibrating part 17 defines at least a pair of receiving portion 720 extending from a periphery of the vibrating part 17 toward a center of the vibrating part 17 for receiving the protrusion portions 703. An extending direction of the receiving portion 702 is perpendicular to the longitudinal direction L1.

The present invention of the acoustic transducer defines protrusion portions, so that the vibrating space of the acoustic transducer is increased in comparison with the typical acoustic transducer.

It will be understood that the above particular embodiment is shown and described by way of illustration only. The principles and the features of the present disclosure may be employed in various and numerous embodiments thereof without departing from the scope of the disclosure as claimed. The above-described embodiment illustrates the scope of the disclosure but do not restrict the scope of the disclosure.

What is claimed is:

1. A transducer comprising:
a diaphragm defining a center portion and a supporting portion surrounding the center portion;
a coil attached to the diaphragm and defining a pair of leading wires;
wherein, the center portion defines a lower surface attached to the coil, an upper surface opposite to the lower surface, and at least a pair of protrusion portions extending from the lower surface toward the upper surface for receiving the leading wires of the coil.

2. The acoustic transducer as claimed in claim 1, wherein the protrusion portions protrude out of the upper surface of the diaphragm.

3. The acoustic transducer as claimed in claim 2, wherein the diaphragm further defines a vibrating part attached to the center portion and the vibrating part defines at least a pair of receiving portion extending from the periphery of the vibrating part toward a center thereof for receiving the protrusion portions.

4. The acoustic transducer as claimed in claim 3, wherein the vibrating part is configured to be a plate.

5. The acoustic transducer as claimed in claim 1, wherein the center portion defines an inner zone, an annular mounting zone extending from the inner zone for mounting the coil, and an outer zone extending from the mounting zone and the protrusion portions is formed on the outer zoon.

6. The acoustic transducer as claimed in claim 5, wherein the inner zone is coplanar with respect to the outer zone.

7. The acoustic transducer as claimed in claim 5, wherein the mounting zone is depressed towards the magnetic system for fixing the coil firmly.

8. The acoustic transducer as claimed in claim 1, wherein the diaphragm defines a plurality of corrugations at the corner thereof.
